(19) United States
(12) Patent Application Publication
(10) Pub. No.: US 2025/0271662 A1
(43) Pub. Date: Aug. 28, 2025

(54) ELECTRONIC DEVICE

(71) Applicant: CARUX TECHNOLOGY PTE. LTD., SINGAPORE (SG)

(72) Inventors: Chun-Wen Chen, Tainan (TW); Wei-Hsuan Lee, Tainan (TW)

(73) Assignee: CARUX TECHNOLOGY PTE. LTD., SINGAPORE (SG)

(21) Appl. No.: 19/023,472

(22) Filed: Jan. 16, 2025

(30) Foreign Application Priority Data
Feb. 26, 2024 (CN) 202410210416.X

(51) Int. Cl. G02B 27/00

(52) U.S. Cl. CPC G02B 27/0018

(57) ABSTRACT

An electronic device includes a first display, a second display, a back frame, and a protection substrate. The second display is adjacent to the first display. The back frame is configured to carry the first display and the second display. The protection substrate is disposed on the first display and the second display. Viewing angle ranges of the first display and the second display are different, and the first display includes a viewing angle control element.

### CROSS-REFERENCE TO RELATED APPLICATION

This application claims the priority benefit of China application serial no. 202410210416.X, filed on Feb. 26, 2024. The entirety of the above-mentioned patent application is hereby incorporated by reference herein and made a part of this specification.

### BACKGROUND

### Technical Field

The disclosure relates to an electronic device.

### Description of Related Art

Multi-panel displays (for example, multi-panel systems of transportation devices) have become increasingly popular. In order to reduce the influence of images on the driver by the panel adjacent to the front passenger, different panels may have different viewing angle specification requirements. When the transportation device is traveling in a dark environment, the image of the panel may be reflected on the windshield and affect the line of sight of the driver. Therefore, the viewing angles of different panels need to be respectively limited to suitable ranges to reduce the above issue.

### SUMMARY

In an embodiment of the disclosure, an electronic device includes a first display, a second display, a back frame, and a protection substrate. The second display is adjacent to the first display. The back frame is configured to carry the first display and the second display. The protection substrate is disposed on the first display and the second display. Viewing angle ranges of the first display and the second display are different, and the first display includes a viewing angle control element.

In another embodiment of the disclosure, an electronic device includes a first panel, a viewing angle control element, and a back frame. The first panel includes a non-active area. The viewing angle control element includes at least one alignment structure, and in a top view direction of the electronic device, the at least one alignment structure overlaps with the non-active area. The back frame is configured to carry the first panel and the viewing angle control element. The back frame includes at least one positioning structure for fixing with the at least one alignment structure.

In order for the features and advantages of the disclosure to be more comprehensible, the following specific embodiments are described in detail in conjunction with the drawings.

### BRIEF DESCRIPTION OF THE DRAWINGS

The drawings are included to provide a further understanding of the disclosure, and the drawings are incorporated into the specification and constitute a part of the specification. The drawings illustrate embodiments of the disclosure and serve to explain principles of the disclosure together with the description.

FIG. 1A is a schematic top view of an electronic device according to a first embodiment of the disclosure.

FIG. 1B is a schematic cross-sectional view corresponding to a section line I-I′ of FIG. 1A.

FIG. 1C is a brightness-viewing angle curve diagram of a first display and a second display in FIG. 1A.

FIG. 2A is a schematic top view of an electronic device according to a second embodiment of the disclosure.

FIG. 2B is a schematic cross-sectional view corresponding to a section line II-II′ of FIG. 2A.

FIG. 3A is a schematic top view of an electronic device according to a third embodiment of the disclosure.

FIG. 3B is a schematic cross-sectional view corresponding to a section line III-III′ of FIG. 3A.

FIG. 4A is a schematic cross-sectional view of an electronic device according to a fourth embodiment of the disclosure.

FIG. 4B is a schematic assembly view of multiple optical films and a patterned adhesive in FIG. 4A.

FIG. 5A and FIG. 5B are respectively partial schematic cross-sectional views of two viewing angle control elements applied to the electronic device of the disclosure.

FIG. 6A is a schematic manufacturing view of a viewing angle control element applied to the electronic device of the disclosure.

FIG. 6B is a schematic assembly view of a panel, a viewing angle control element, and a back frame.

FIG. 7A and FIG. 7B are respectively schematic cross-sectional views of two electronic devices according to a fifth embodiment and a sixth embodiment of the disclosure.

### DETAILED DESCRIPTION OF DISCLOSED EMBODIMENTS

An electronic device according to the embodiments of the disclosure is described in detail below. It should be understood that the following description provides many different embodiments for implementing different aspects of some embodiments of the disclosure. The specific elements and arrangement manners described below are only for the purpose of simply and clearly describing some embodiments of the disclosure. Of course, these are only examples and are not limitations of the disclosure. In addition, similar and/or corresponding reference numerals may be used in different embodiments to identify similar and/or corresponding elements in order to clearly illustrate the disclosure. However, the use of the similar and/or corresponding reference numerals is only for the purpose of simply and clearly describing some embodiments of the disclosure and does not represent any relevance between the different embodiments and/or structures discussed.

It should be understood that relative terms such as “lower” or “bottom” or “upper” or “top” may be used in the embodiments to describe the relative relationship of an element to another element in the drawing. It should be understood that if a device in the drawing is turned upside down, elements described as being on the “lower” side will then become elements on the “higher” side. The embodiments of the disclosure may be understood in conjunction with the drawings, and the drawings are also regarded as a part of the description of the disclosure. It should be understood that the drawings of the disclosure are not drawn to scale, and in fact, the sizes of elements may be arbitrarily enlarged or reduced in order to clearly illustrate the features of the disclosure.

When a structure (or layer, element, base) is described in the disclosure as being located on/above another structure (or layer, element, base), it may mean that the two structures are adjacent and directly connected or it may mean that the two structures are adjacent but not directly connected. Indirect connection means that there is at least one intermediate structure (or intermediate layer, intermediate element, intermediate base, intermediate spacing) between the two structures. A lower surface of one structure is adjacent or directly connected to an upper surface of the intermediate structure, and an upper surface of the other structure is adjacent or directly connected to a lower surface of the intermediate structure. The intermediate structure may be composed of a single-layer or multi-layer physical structure or non-physical structure, which is not limited. In the disclosure, when a certain structure is disposed “on” another structure, it may mean that the certain structure is “directly” on the other structure or it may mean that the certain structure is “indirectly” on the other structure, that is, at least one structure is also sandwiched between the certain structure and the other structure.

In addition, it should be understood that terms such as “first” and “second” used in the specification and the claims are used to modify elements and do not imply and represent that the element(s) have any previous ordinal numbers, nor do the terms represent the order of a certain element and another element or the order of a manufacturing method. The use of the ordinal numbers is only used to clearly distinguish between an element with a certain name and another element with the same name. The claims and the specification may not use the same terms, whereby a first element in the specification may be a second element in the claims.

In some embodiments of the disclosure, terms such as “connection” and “interconnection” related to bonding and connection, unless otherwise defined, may refer to two structures being in direct contact or may also refer to two structures not being in direct contact, wherein there is another structure provided between the two structures. Furthermore, the terms related to bonding and connection may also include the case where the two structures are both movable or the two structures are both fixed. In addition, the term “electrical connection” or “coupling” includes any direct and indirect electrical connection means.

As used herein, the terms “about”, “substantially”, and “roughly” are generally interpreted as within 10%, 5%, 3%, 2%, 1%, or 0.5% of a given value or range. Unless otherwise defined, the term “a range is between a first value and a second value” means that the range includes the first value, the second value, and other values therebetween. In addition, there may be a certain error between any two values or directions for comparison. If the first value is equal to the second value, it implies that there may be an error of about 10% between the first value and the second value. If a first direction is perpendicular to a second direction, an angle between the first direction and the second direction may be between 80 degrees and 100 degrees; and if the first direction is parallel to the second direction, the angle between the first direction and the second direction may be between 0 degrees and 10 degrees. In the disclosure, the terms “a given range is from a first value to a second value” and “a given range falls within a range from a first value to a second value” mean that the given range includes the first value, the second value, and other values therebetween.

Furthermore, according to the embodiments of the disclosure, an optical microscope (OM), a scanning electron microscope (SEM), an α-step film thickness profiler, an ellipsometer, or other suitable manners may be used to measure the thickness, the length, or the width of each element or the distance or the angle between elements. In detail, according to some embodiments, the scanning electron microscope may be used to obtain a cross-sectional image of a structure and measure the thickness, the length, or the width of each element or the distance or the angle between the elements.

Throughout the specification and the appended claims of the disclosure, certain terms may be used to refer to specific elements. It should be understood by persons skilled in the art that electronic device manufacturers may refer to the same element by different names. The disclosure does not intend to distinguish between elements with the same function but different names. In the following specification and claims, words such as “comprising”, “including”, and “having” are open-ended words, so the words should be interpreted as “comprising but not limited to . . . ”. Therefore, when the terms “comprise”, “include”, and/or “have” are used in the description of the disclosure, the terms specify the presence of a corresponding feature, region, step, operation, and/or element, but do not exclude the presence of one or more corresponding features, regions, steps, operations, and/or elements.

It should be understood that the following embodiments may be implemented by replacing, reorganizing, or combining features of several different embodiments without departing from the spirit of the disclosure to complete other embodiments. The features of the embodiments may be used in any combination as long as the features do not violate the spirit of the invention or conflict with each other.

Unless otherwise defined, all terms (including technical and scientific terms) used herein have the same meaning as commonly understood by persons skilled in the art to which the disclosure belongs. It can be understood that the terms such as the terms defined in commonly used dictionaries should be interpreted as having meanings consistent with the relevant art and the background or context of the disclosure, and should not be interpreted in an idealized or overly formal manner, unless otherwise defined in the embodiments of the disclosure. The disclosure may be understood through referring to the following detailed description in conjunction with the drawings. It should be noted that in order to facilitate the understanding by the reader and for the simplicity of the drawings, multiple drawings in the disclosure only depict a part of the electronic device, and specific elements in the drawings are not drawn according to the actual scale. In addition, the number and the size of each element in the drawings are only for illustration and are not intended to limit the scope of the disclosure.

The electronic device of the disclosure may include an electronic element. The electronic element may include a passive element, an active element, or a combination thereof, such as a capacitor, a resistor, an inductor, a varactor diode, a variable capacitor, a filter, a diode, a transistor, a sensor, a micro-electromechanical system element (MEMS), and a liquid crystal chip, but not limited thereto. The diode may include a light emitting diode or a non-light emitting diode. The diode includes a P-N junction diode, a PIN diode, or a constant current diode. The light emitting diode may include, for example, an organic light emitting diode (OLED), a mini LED, a micro LED, a quantum dot LED, fluorescence, phosphor, other suitable materials, or a combination thereof, but not limited thereto. The sensor may include, for example, a capacitive sensor, an optical sensor, an electromagnetic sensor, a fingerprint sensor (FPS), a touch sensor, an antenna, a pen sensor, etc., but not limited thereto. The following description will take the display device as the electronic device to illustrate the disclosure, but not limited thereto.

The electronic device may include an imaging device, a bonding device, a display device, a backlight device, an antenna device, a splicing device, a touch display, a curved display, or a free shape display, but not limited thereto. The electronic device may include, for example, liquid crystal, a light emitting diode, fluorescence, phosphor, other suitable display media, or a combination thereof, but not limited thereto. The display device may be a non-self-luminous display device or a self-luminous display device. The antenna device may be a liquid crystal antenna device or a non-liquid crystal antenna device, and the sensing device may be a sensing device for sensing capacitance, light, heat energy, or ultrasound, but not limited thereto. The splicing device may be, for example, a display splicing device or an antenna splicing device, but not limited thereto. It should be noted that the electronic device can be any arrangement or combination thereof, but not limited thereto. The electronic device may be a bendable or flexible electronic device. In addition, the appearance of the electronic device may be rectangular, circular, polygonal, a shape with curved edges, or other suitable shapes. The electronic device may have a peripheral system such as a driving system, a control system, a light source system, and a rack system to support the display device, the antenna device, or the splicing device. It should be noted that the following embodiments may be implemented by replacing, reorganizing, or mixing features of several different embodiments without departing from the spirit of the disclosure to complete other embodiments. The features of the embodiments may be mixed and matched for use as long as the features do not violate the spirit of the invention or conflict with each other. It should be noted that the technical solutions provided in the following different embodiments may be replaced, combined, or mixed with each other to form another embodiment without violating the spirit of the disclosure.

The electronic device may be applied to a transportation device, such as a vehicle-mounted device and a heavy motorcycle, or any other appropriate non-transportation device.

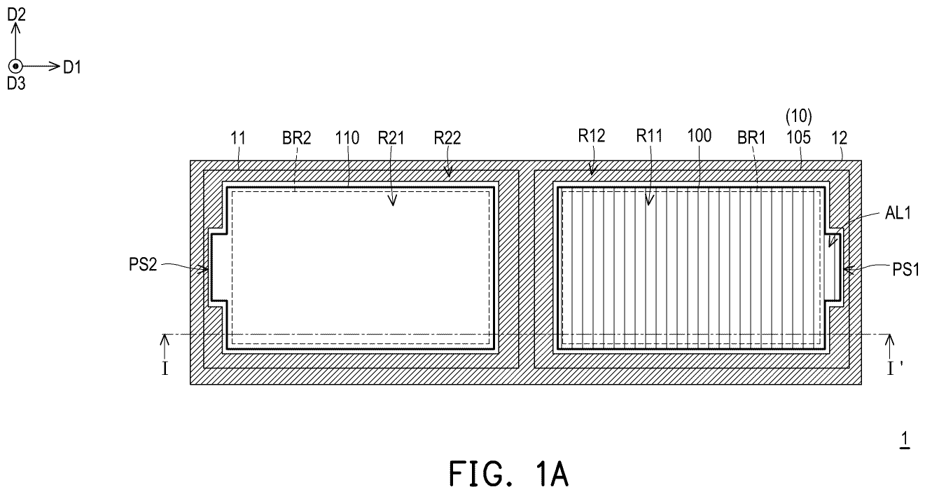

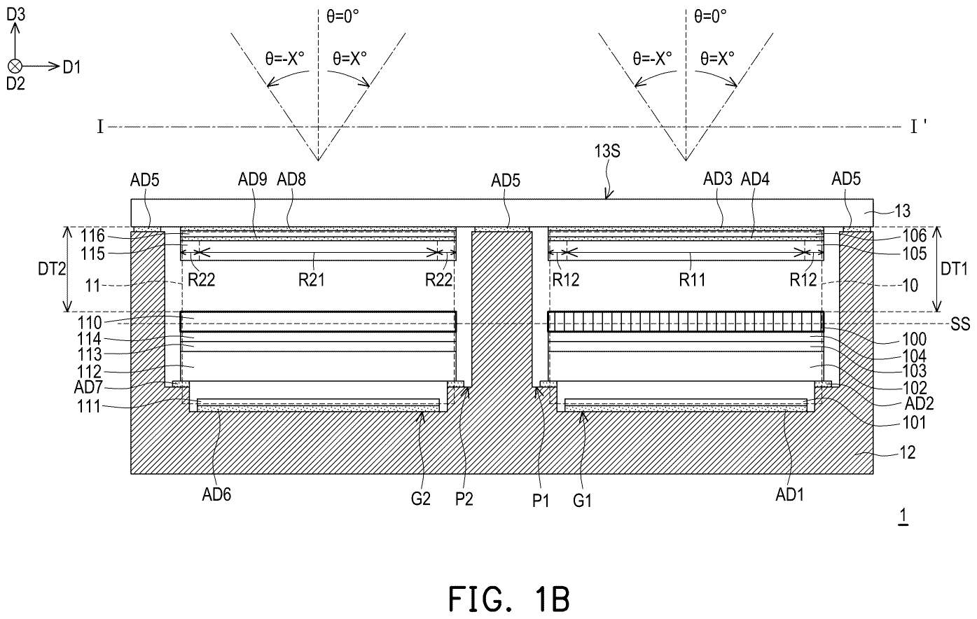

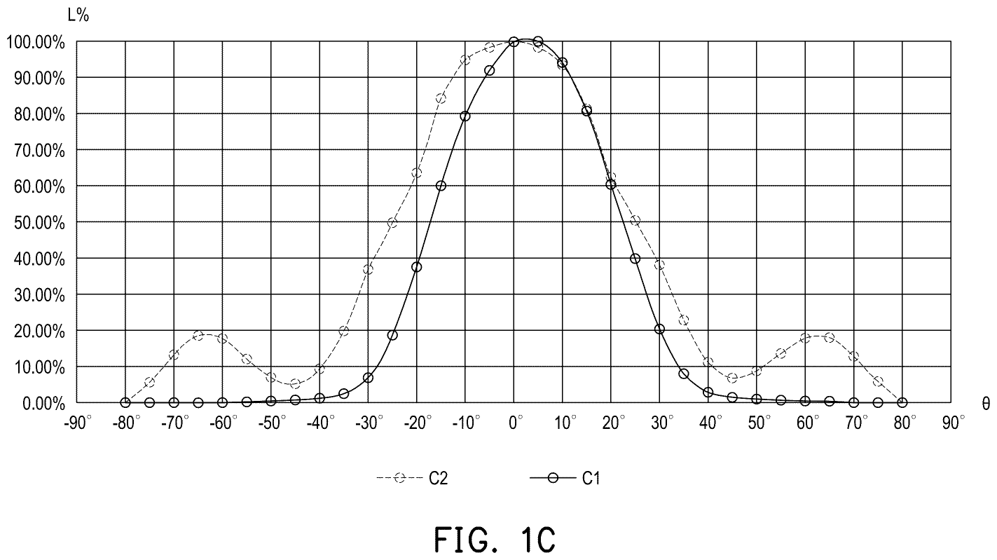

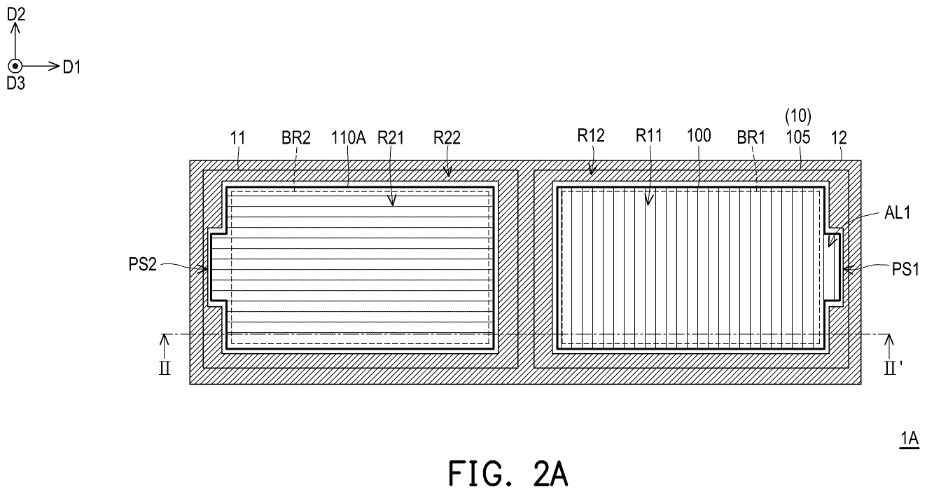

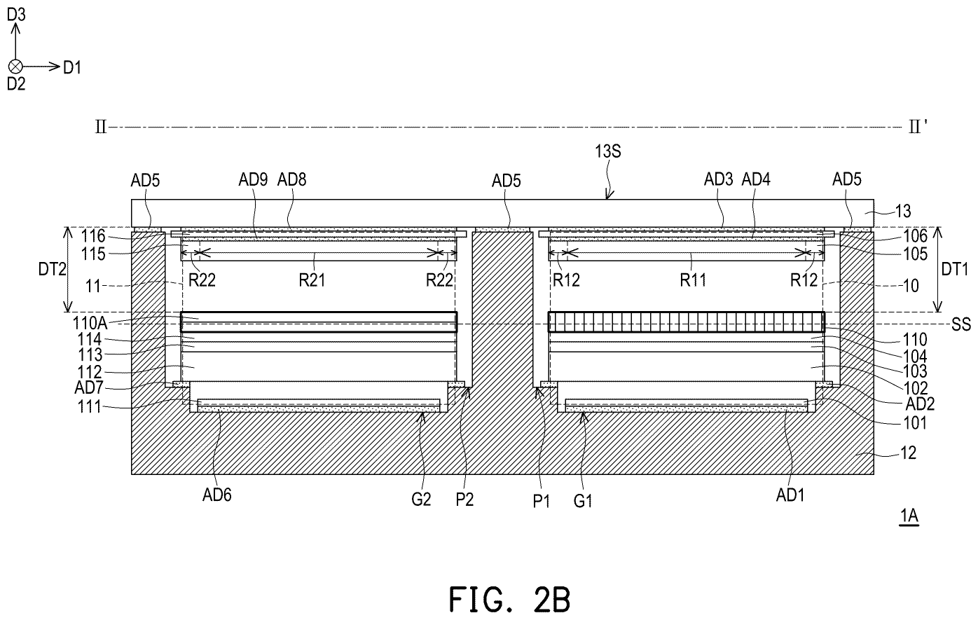

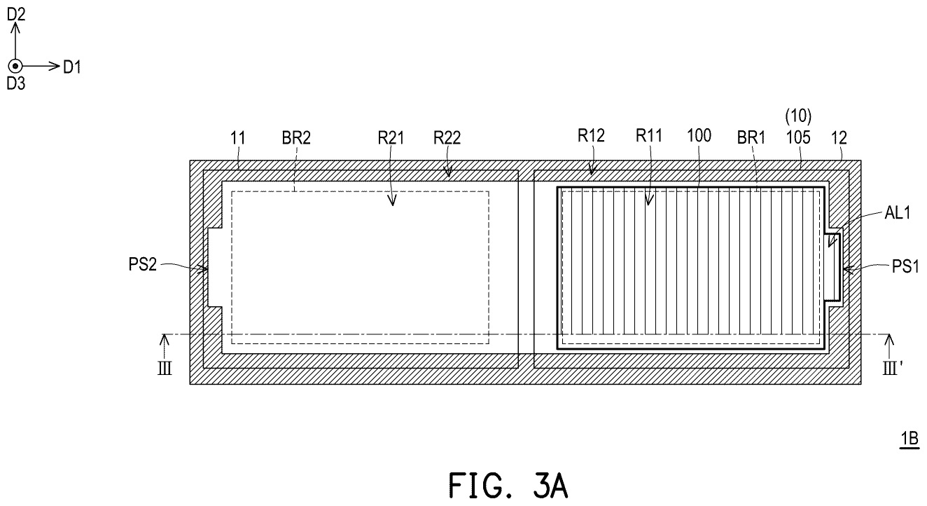

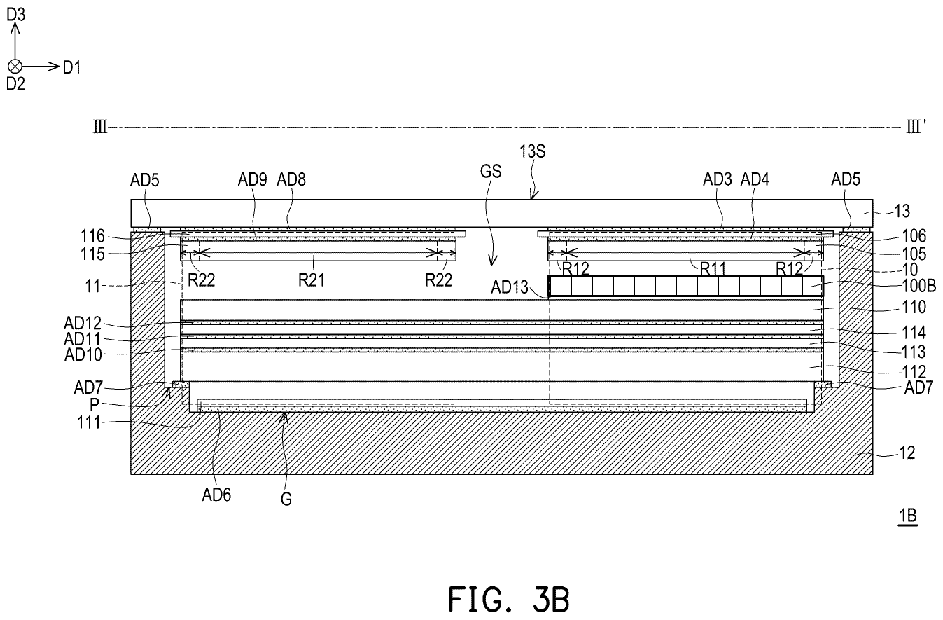

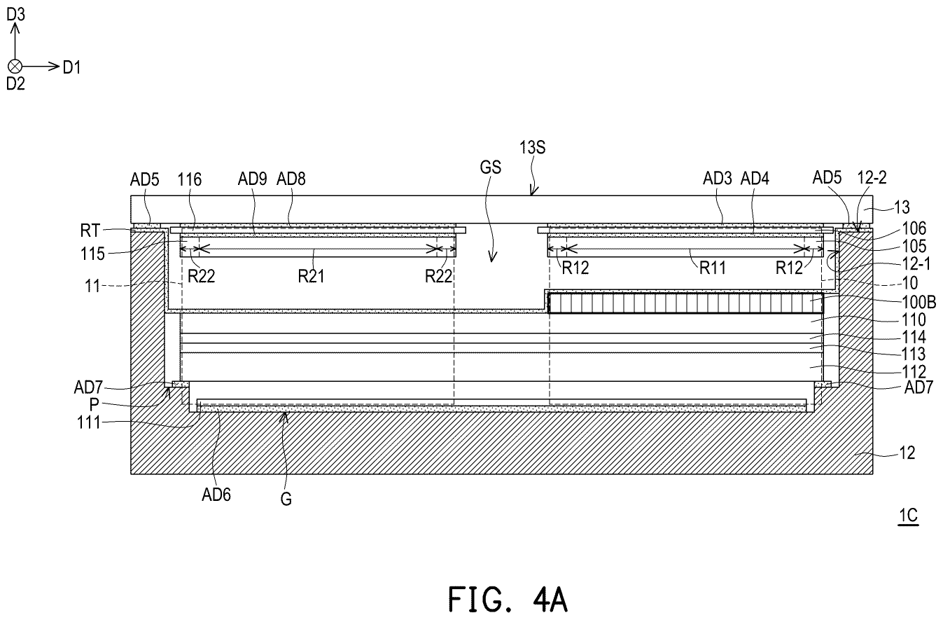

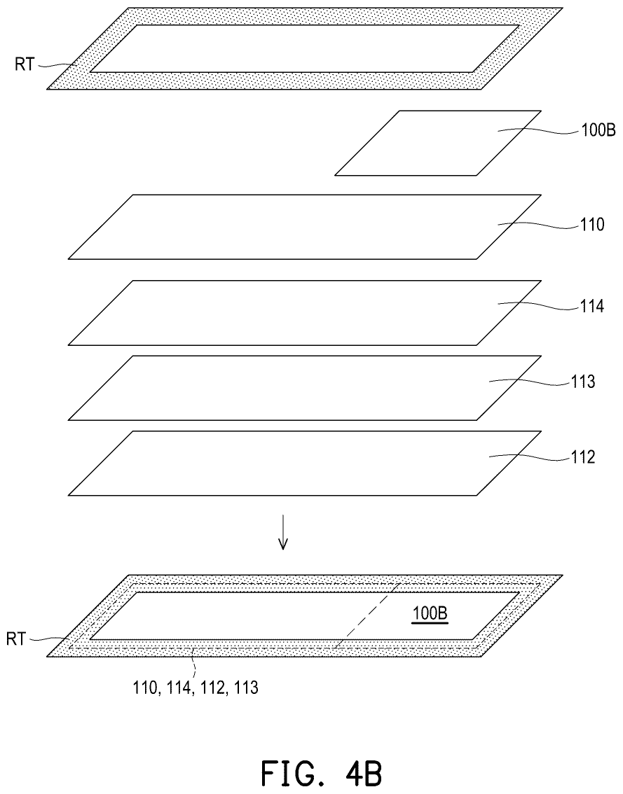

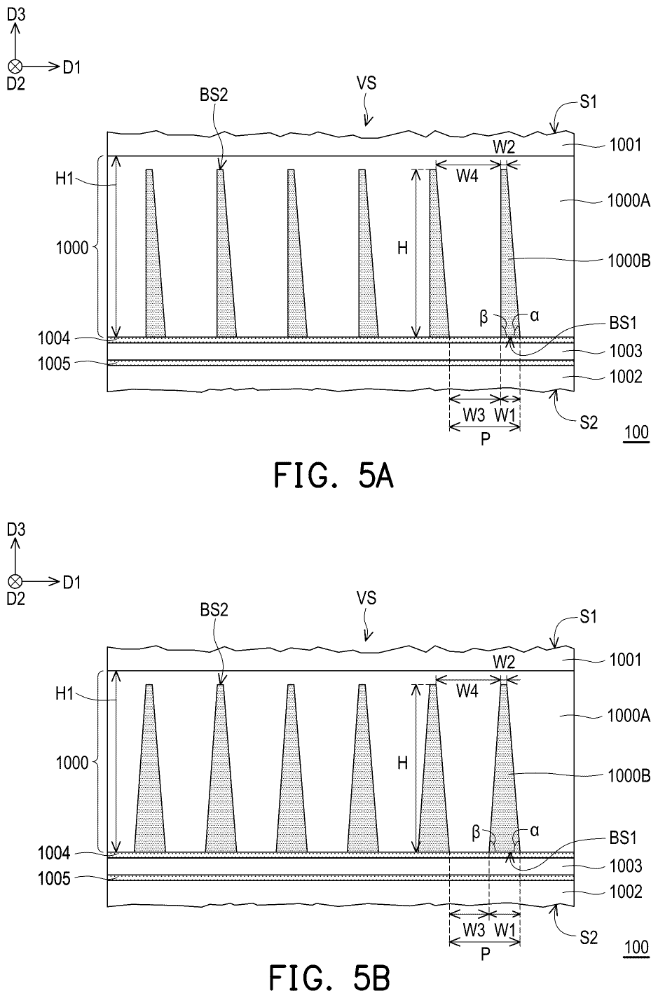

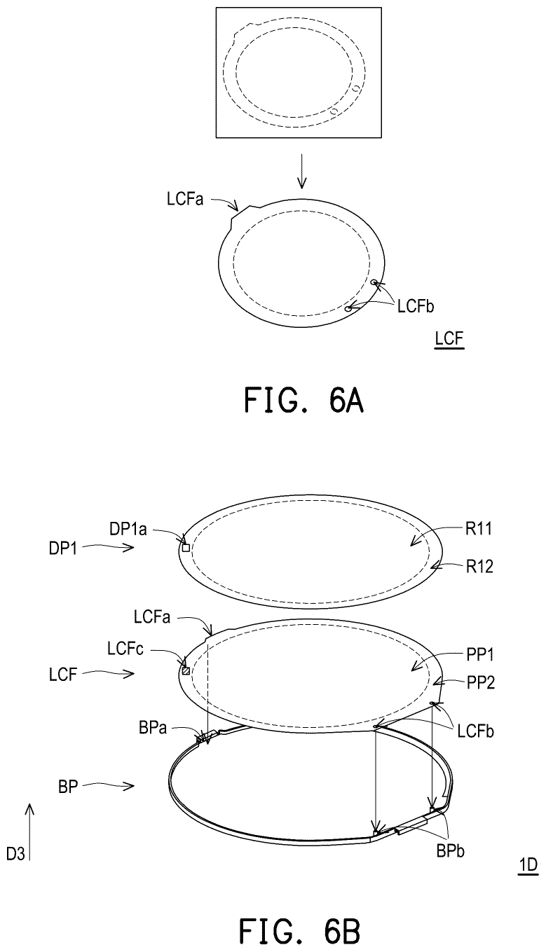

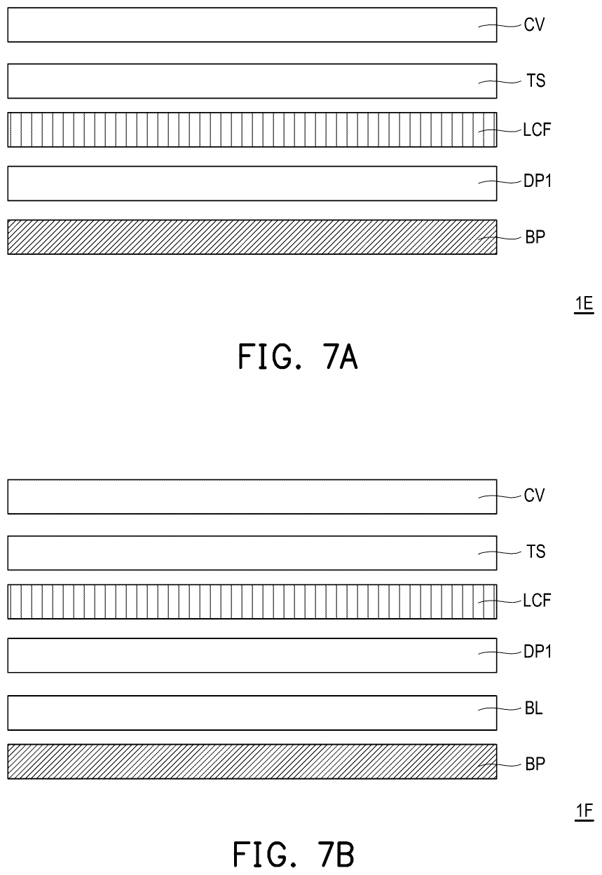

FIG. 1A is a schematic top view of an electronic device according to a first embodiment of the disclosure. FIG. 1B is a schematic cross-sectional view corresponding to a section line I-I′ of FIG. 1A. FIG. 1C is a brightness-viewing angle curve diagram of a first display and a second display in FIG. 1A. FIG. 2A is a schematic top view of an electronic device according to a second embodiment of the disclosure. FIG. 2B is a schematic cross-sectional view corresponding to a section line II-II′ of FIG. 2A. FIG. 3A is a schematic top view of an electronic device according to a third embodiment of the disclosure. FIG. 3B is a schematic cross-sectional view corresponding to a section line III-III′ of FIG. 3A. FIG. 4A is a schematic cross-sectional view of an electronic device according to a fourth embodiment of the disclosure. FIG. 4B is a schematic assembly view of multiple optical films and a patterned adhesive in FIG. 4A. FIG. 5A and FIG. 5B are respectively partial schematic cross-sectional views of two viewing angle control elements applied to the electronic device of the disclosure. FIG. 6A is a schematic manufacturing view of a viewing angle control element applied to the electronic device of the disclosure. FIG. 6B is a schematic assembly view of a panel, a viewing angle control element, and a back frame. FIG. 7A and FIG. 7B are respectively schematic cross-sectional views of two electronic devices according to a fifth embodiment and a sixth embodiment of the disclosure. It should be noted that the following embodiments may be implemented by replacing, reorganizing, or mixing features of several different embodiments without departing from the spirit of the disclosure to complete other embodiments. The features of the embodiments may be mixed and matched for use as long as the features do not violate the spirit of the invention or conflict with each other.

Please refer to FIG. 1A and FIG. 1B first. An electronic device 1 may include a first display 10, a second display 11, a back frame 12, and a protection substrate 13. The second display 11 is adjacent to the first display 10. The back frame 12 is configured to carry the first display 10 and the second display 11. The protection substrate 13 is disposed on the first display 10 and the second display 11. Viewing angle ranges of the first display 10 and the second display 11 are different, and the first display 10 includes a viewing angle control element 100.

In detail, the first display 10 and the second display 11 are configured to display images. The first display 10 and the second display 11 may include self-luminous displays or non-self-luminous displays. The self-luminous display may include a light emitting diode display, an organic light emitting diode display, a mini light emitting diode display, a micro light emitting diode display, or a quantum dot light emitting diode display, but not limited thereto. The non-self-luminous display may include a liquid crystal display or other suitable displays, but not limited thereto.

Taking the non-self-luminous display as an example, as shown in FIG. 1B, in addition to the viewing angle control element 100, the first display 10 may further include a light source element 101 (such as including a circuit board (not shown) and multiple light emitting units (not shown) disposed on the circuit board), an optical element 102, an optical element 103, an optical element 104, a first panel 105, and/or a touch element 106, but not limited thereto, and any of the above elements may be removed or other elements may be added according to requirements. The light source element 101 is configured to provide light. For example, although not shown, the light source element 101 may include multiple light emitting diodes or other suitable light emitting elements. For example, the light emitting diodes may be arranged in an array in a first direction D1 and a second direction D2, but not limited thereto, and the light emitting diodes may be arranged in other ways according to requirements. The first direction D1 and the second direction D2 are, for example, both perpendicular to a top view direction (for example, a third direction D3) of the electronic device 1, and the first direction D1 is different from the second direction D2. For example, the first direction D1 and the second direction D2 are perpendicular to each other, but not limited thereto. The viewing angle control element 100, the light source element 101, the optical element 102, the optical element 103, and the optical element 104 are, for example, combined into a backlight module, but not limited thereto. The backlight module may add or omit any of the above elements according to requirements. The backlight module shown in FIG. 1B is exemplified as a direct-type backlight module, but not limited thereto, and the backlight module may be changed to a side-type backlight module according to requirements.

In some embodiments, the back frame 12 may include a groove G1 for accommodating the light source element 101, and the light source element 101 may be fixed onto the back frame 12 through an adhesive AD1, but not limited thereto. The adhesive AD1 may include double-sided glue, double-sided tape, curing glue (thermal curing, light curing, moisture curing, or other suitable curing glue), or other materials with adhesiveness. The adhesive AD1 may include a transparent or non-transparent adhesive material.

The optical element 102 is disposed above the light source element 101. In some embodiments, along the first direction D1 or the second direction D2, the width of the optical element 102 may be greater than the width of the light source element 101. In some embodiments, the back frame 12 may include a platform portion P1 for carrying the optical element 102. In some embodiments, the platform portion P1, for example, surrounds the groove G1 and protrudes relative to the groove G1, so that the optical element 102 disposed on the platform portion P1 may maintain an appropriate distance from the light source element 101, which contributes to heat dissipation of the light source element 101 or reducing heat deformation of the optical element 102, but not limited thereto. The appearance of the platform portion P1 in FIG. 1B may be adjusted according to requirements. In some embodiments, the optical element 102 may be fixed onto the platform portion P1 through an adhesive AD2, but not limited thereto. The adhesive AD2 may be, for example, ring-shaped or divided into multiple sub-portions. Reference may be made to the material of the adhesive AD1 for the material of the adhesive AD2, which will not be repeated here. In some embodiments, the back frame 12 may include a single material or a composite material, such as a metal material, a polymer material, a plastic material, a ceramic material, or other suitable materials.

In some embodiments, the optical element 102 may include a light guide plate, other light guide elements, or other suitable optical sheets, but not limited thereto. Although FIG. 1B shows that the light source element 101 is disposed below the optical element 102, that is, the architecture of the direct-type backlight module is adopted, in other embodiments not shown, the light source element 101 may be disposed next to a side surface of the optical element 102, that is, the architecture of the side-type backlight module may be adopted.

The optical element 103 is disposed on the optical element 102. In some embodiments, although not shown, the optical element 103 may be selectively fixed onto the optical element 102 through a light transmitting adhesive (not shown). The light transmitting adhesive may include an optical clear adhesive (OCA), an optical clear resin (OCR), other suitable adhesives, or a combination thereof, but not limited thereto. The optical element 103 may include a diffusion sheet to improve light uniformity, but not limited thereto. The optical element 103 may be replaced by other suitable functional sheets according to requirements.

In some embodiments, the optical element 104 is disposed on the optical element 103. In some embodiments, although not shown, the optical element 104 may be fixed onto the optical element 103 through a light transmitting adhesive. The optical element 104 may include a prism sheet, such as a brightness enhancement film (BEF) or other suitable functional sheets, but not limited thereto.

In some embodiments, the viewing angle control element 100 is disposed on the optical element 104. In some embodiments, although not shown, the viewing angle control element 100 may be fixed onto the optical element 104 through a light transmitting adhesive. The viewing angle control element 100 is configured to control a viewing angle range of the first display 10. For example, the viewing angle control element 100 may include an electrically controlled viewing angle control element or a non-electrically controlled viewing angle control element. The electrically controlled viewing angle control element may include a viewing angle control element containing any suitable liquid crystal material or a liquid viewing angle control element containing other materials (dyes), but not limited thereto. The non-electrically controlled viewing angle control element may include a non-electrically controlled viewing angle control element containing multiple light shielding portions, such as a Louver film or other suitable structures, but not limited thereto. The use of the non-electrically controlled viewing angle control element contributes to implementing a thinner and/or miniaturized electronic device 1.

Taking the non-electrically controlled viewing angle control element as an example, as shown in FIG. 5A or FIG. 5B, the viewing angle control element 100 may include a light shielding portion 1000, a protection layer 1001, a protection layer 1002, a reflective polarizer 1003, a light transmitting adhesive 1004, and/or a light transmitting adhesive 1005, but not limited thereto. The structure of the viewing angle control element in FIG. 5B is only an example, and any one element may be removed or other elements may be added according to requirements.

In some embodiments, the light shielding portion 1000 may include a light transmitting layer 1000A and multiple light shielding structures 1000B embedded in the light transmitting layer 1000A. The material of the light transmitting layer 1000A may include a light transmitting organic or inorganic material, such as a resin or other light transmitting materials, but not limited thereto. The material of the light shielding structures 1000B may include black ink or other light absorbing materials. In some embodiments, a trench may be formed in the light transmitting layer 1000A and then filled with a light absorbing material to form the light shielding portion 1000, but not limited thereto. In some embodiments, the light transmitting layer 1000A may be disposed between the light shielding structures 1000B, but not limited thereto. In some embodiments, in the third direction D3, a thickness H of the light shielding structure 1000B may be less than or equal to a thickness H1 of the light transmitting layer 1000A.

As shown in FIG. 5A or FIG. 5B, the light shielding structures 1000B may be sequentially arranged in the first direction D1 and extend in the second direction D2 to limit the viewing angle range in the first direction D1, but not limited thereto. Alternatively, although not shown, the light shielding structures 1000B may be sequentially arranged in the second direction D2 and extend in the first direction D1 to limit the viewing angle range in the second direction D2. However, the viewing angle limitation range of the disclosure is not limited to the first direction D1 or the second direction D2, that is, the arrangement direction of the light shielding structures 1000B may be adjusted according to requirements.

The viewing angle range in different directions may be adjusted through modulating the design parameters or the arrangement of the light shielding structures 1000B. The design parameters may include a first bottom angle α of the light shielding structure 1000B, a second bottom angle R of the light shielding structure 1000B, a width W1 of a first surface BS1 (a surface adjacent to the back frame 12 or away from a viewing side VS of the electronic device) of the light shielding structure 1000B in the first direction D1, a width W2 of a second surface BS2 (a surface away from the back frame 12 or adjacent to the viewing side VS of the electronic device) of the light shielding structure 1000B in the first direction D1, the thickness H of the light shielding structure 1000B in the third direction D3, a distance W3 between the first surfaces BS1 of two adjacent light shielding structures 1000B in the first direction D1, a distance W4 between the second surfaces BS2 of two adjacent light shielding structures 1000B in the first direction D1, a pitch P of two adjacent light shielding structures 1000B in the first direction D1, and a cross-sectional shape of the light shielding structure 1000B, but not limited thereto. The pitch P of the two adjacent light shielding structures 1000B is, for example, defined by a distance between the same sides or the centers of the two adjacent light shielding structures 1000B. FIG. 5A is, for example, defined by the same sides (the right sides) of the two adjacent light shielding structures 1000B.

In some embodiments, as shown in FIG. 5A, the first bottom angle α may be different from the second bottom angle β. In some other embodiments, as shown in FIG. 5B, the first bottom angle α may be the same as the second bottom angle β. In some embodiments, the first bottom angle α and/or the second bottom angle β may be greater than 0 degrees and less than or equal to 90 degrees. In some embodiments, as shown in FIG. 5A and FIG. 5B, the width W1 of the first surface BS1 may be different from the width W2 of the second surface BS2, so that the cross-sectional shape of the light shielding structure 1000B is trapezoidal, but not limited thereto. In some other embodiments, although not shown, the width W1 of the first surface BS1 may be the same as the width W2 of the second surface BS2, so that the cross-sectional shape of the light shielding structure 1000B is rectangular, but not limited thereto. In some embodiments, as shown in FIG. 5A, two adjacent light shielding structures 1000B in the first direction D1 may have asymmetrical structures. In some other embodiments, as shown in FIG. 5B, two adjacent light shielding structures 1000B in the first direction D1 may have symmetrical structures. In some embodiments, as shown in FIG. 5A and FIG. 5B, the thickness H may be greater than the pitch P, the width W1 of the first surface BS1, and/or the distance W3. In some embodiments, a ratio of the thickness H to the pitch P may be greater than 1 and less than or equal to 10, greater than 2 and less than or equal to 8, or greater than 3 and less than or equal to 7, but not limited thereto. In some embodiments, the distance W3 may be greater than or equal to the width W1. In some embodiments, the distance W3 may be less than or equal to the width W1. In some embodiments, a ratio of the distance W3 to the width W1 may be greater than or equal to 0.5 and less than or equal to 2, or greater than or equal to 0.75 and less than or equal to 1.5, but not limited thereto. In some embodiments, the pitch P may be designed to be less than the pixel size of the first panel 105 (refer to FIG. 1B) to reduce the moiré pattern phenomenon, but not limited thereto. In some embodiments, the pitch P may be between 10 μm and 70 μm (10 μm≤pitch P≤70 μm), between 20 μm and 60 μm (20 μm≤pitch P≤60 μm), or between 30 μm and 40 μm (30 μm≤pitch P≤40 μm), such as 38.5 μm, but not limited thereto.

In some embodiments, the protection layer 1001 is, for example, disposed on the viewing side VS of the light shielding portion 1000, and the protection layer 1002 is disposed on a side of the light shielding portion 1000 away from the viewing side VS, wherein the reflective polarizer 1003 is disposed between the protection layer 1002 and the light shielding portion 1000 and is fixed onto the light shielding portion 1000 through the light transmitting adhesive 1004, and the protection layer 1002 is fixed onto the reflective polarizer 1003 through the light transmitting adhesive 1005, but not limited thereto. In other embodiments, the reflective polarizer 1003 may be selectively replaced by other light source films.

The materials of the protection layer 1001 and/or the protection layer 1002 may include a light transmitting inorganic or organic material, such as plastic, resin, or other suitable materials, but not limited thereto. The materials of the light transmitting adhesive 1004 and the light transmitting adhesive 1005 may include optical clear adhesive or optical clear resin, but not limited thereto. In some embodiments, the viewing angle control element 100 includes a first surface S1 adjacent to the protection substrate 13 and a second surface S2 opposite to the first surface S1. In other words, the viewing angle control element 100 includes the first surface S1 adjacent to the viewing side VS of the electronic device and the second surface S2 opposite to the first surface S1. The haze of the first surface S1 may be greater than the haze of the second surface S2. In some embodiments, the haze of the first surface S1 may be less than or equal to 80%, and the haze of the second surface S2 may be greater than 0 and less than or equal to 10%. In some embodiments, the haze of the first surface S1 may be less than or equal to 75%, less than or equal to 70%, or less than or equal to 65%, but not limited thereto. In some embodiments, the haze of the second surface S2 may be greater than 0 and less than or equal to 10%, greater than 0 and less than or equal to 15%, greater than 0 and less than or equal to 20%, or greater than 0 and less than or equal to 25%, but not limited thereto. Taking FIG. 5A or FIG. 5B as an example, the first surface S1 of the viewing angle control element 100 may be an upper surface of the protection layer 1001 in FIG. 5A or FIG. 5B, and the second surface S2 of the viewing angle control element 100 may be a lower surface of the protection layer 1002 in FIG. 5A or FIG. 5B. In some embodiments, the upper surface of the protection layer 1001 and the lower surface of the protection layer 1002 may be subjected to a surface atomization processing to reduce moiré, prevent scratches, and/or conceal defects, but not limited thereto. In addition, through the design of the haze of the first surface S1 being greater than the haze of the second surface S2 and/or the haze of the first surface S1 being less than or equal to 80%, adverse influence on viewing angle control caused by light dispersion due to excessive haze can be reduced. In addition, through the design of the haze of the second surface S2 being greater than 0 and less than or equal to 10%, a large amount of light loss caused by an incident light passing through the second surface S2 can be reduced. Through the above haze design, a large part of light can pass through the second surface S2. For example, the haze of the first surface S1 may be 40%, 45%, 50%, 55%, or 60%, and the haze of the second surface S2 may be 5%, 7%, or 9%, but not limited thereto.

Please refer to FIG. 1A and FIG. 1B again. The first panel 105 and the touch element 106 are sequentially disposed above the viewing angle control element 100, but not limited thereto. In some embodiments, the touch element 106 may be fixed onto a surface of the protection substrate 13 facing the viewing angle control element 100 through a light transmitting adhesive AD3, but not limited thereto. In some embodiments, the first panel 105 may be fixed onto a surface of the touch element 106 facing the viewing angle control element 100 through a light transmitting adhesive AD4, and the protection substrate 13 may be fixed onto the back frame 12 through an adhesive AD5 (a patterned adhesive), but not limited thereto. In other words, the touch element 106 may be disposed between the protection substrate 13 and the first panel 105, the touch element 106 and the protection substrate 13 are fixed through the light transmitting adhesive AD3, and the touch element 106 and the first panel 105 are fixed through the light transmitting adhesive AD4. In some embodiments, the touch element 106 and/or the first panel 105 are, for example, not in contact with the back frame 12, that is, in the first direction D1 or the second direction D2, the touch element 106 and/or the first panel 105 are spaced from the back frame 12 by a distance (greater than 0), but not limited thereto. In other embodiments (not shown), the touch element 106 and/or the first panel 105 are, for example, partially in contact with the back frame 12, but not limited thereto. The protection substrate 13 may include a hard substrate, such as a glass substrate, a ceramic substrate, a plastic substrate, or other suitable materials, but not limited thereto. The material of the plastic substrate may include polycarbonate (PC), polyimide (PI), polypropylene (PP), polyethylene terephthalate (PET), other suitable flexible materials, or a combination of the above materials, but not limited thereto. The light transmitting adhesive AD3 and/or the light transmitting adhesive AD4 may include optical clear adhesives or optical clear resins, but not limited thereto. Reference may be made to the material of the adhesive AD1 for the material of the adhesive AD5, which will not be repeated here. Through fixing the first panel 105 onto the side of the protection substrate 13, scratching caused by the first panel 105 touching the viewing angle control element 100 can be reduced, thereby improving the effect of the electronic device.

The touch element 106 may include a self-capacitive touch element or a mutual-capacitive touch element, and the touch element 106 may include multiple touch electrodes (not shown) to implement a physical touch or hovering touch function, but not limited thereto.

The first panel 105 is a display panel, such as a liquid crystal display panel, but not limited thereto. The first panel 105 may have an active area R11 and a non-active area R12 adjacent to the active area R11. The active area R11 may be configured to display images (or for other functional applications, such as touch or detection), and the non-active area R12 may be configured to provide peripheral circuits (not shown). In some embodiments, as shown in FIG. 1A, the non-active area R12 may be adjacent to at least one side of the active area R11, and the non-active area R12 may, for example, surround the active area R11, but not limited thereto. In FIG. 1A, in order to clearly illustrate the relative configuration relationship between the viewing angle control element 100 and the back frame 12, the edge of the first panel 105 is shown by a thin solid line, and a boundary BR1 between the active area R11 and the non-active area R12 is shown by a thin dotted line.

In some embodiments, as shown in FIG. 1A, the viewing angle control element 100 may include at least one alignment structure AL1, and in the top view direction (for example, the third direction D3) of the electronic device 1, the at least one alignment structure AL1 overlaps with the non-active area R12. In some embodiments, the at least one alignment structure AL1 may be a recessed portion (not shown), a protruding portion, or a through hole of the viewing angle control element 100, and the back frame 12 may include at least one positioning structure PS1 for fixing with the at least one alignment structure AL1. FIG. 1A schematically shows one alignment structure AL1 and one positioning structure PS1, wherein the alignment structure AL1 is the protruding portion of the viewing angle control element 100, and the positioning structure PS1 is a recessed portion having a shape roughly complementary to the protruding portion, but not limited thereto. For example, although not shown, the number of the alignment structure AL1 and the positioning structure PS1 may be greater than one. In addition, the alignment structure AL1 may be the recessed portion of the viewing angle control element 100, and the positioning structure PS1 may be a protruding portion having a shape roughly complementary to the recessed portion, but not limited thereto. Alternatively, the alignment structure AL1 may be the through hole of the viewing angle control element 100, and the positioning structure PS1 may be a column passing through the through hole, but not limited thereto.

In some embodiments, in addition to assisting in alignment, the alignment structure AL1 may also be configured to identify an axial direction of the light shielding portion 1000 of the viewing angle control element 100 or the front and back sides of the viewing angle control element 100, which contributes to aligning free shape or rectangular electronic devices. That is, regardless of the shape of the electronic device 1 being rectangular, circular, triangular, other polygonal shapes, or irregular shapes, through designing the viewing angle control element 100 with the above alignment structure, the accuracy of the alignment and the assembly between the viewing angle control element 100 and the back frame 12 or other adjacent elements (for example, the first panel 105) can be improved.

In other embodiments, although not shown, similar to the viewing angle control element 100, the optical element 102, the optical element 103, and/or the optical element 104 may also include at least one alignment structure, and the at least one alignment structure may be a recessed portion (not shown), a protruding portion, or a through hole. Through designing the at least one alignment structure on the above optical elements, the accuracy of the alignment and the assembly between the above optical elements and the back frame 12 or other adjacent elements (for example, the first panel 105) can be improved.

Similarly, the second display 11 may also be a self-luminous display or a non-self-luminous display. Taking the non-self-luminous display as an example, as shown in FIG. 1B, the second display 11 may include a light source element 111, an optical element 112, an optical element 113, an optical element 114, an optical element 110, a second panel 115, and a touch element 116, but not limited thereto. The light source element 111, the optical element 112, the optical element 113, the optical element 114, and the optical element 110 are, for example, combined into a backlight module, but not limited thereto. The backlight module may add or omit any of the above elements according to requirements.

Reference may be made to the description of the light source element 101 for the detailed content of the light source element 111, which will not be repeated here. In some embodiments, the back frame 12 may further include a groove G2 for accommodating the light source element 111, and the light source element 111 may be fixed in the groove G2 through an adhesive AD6, but not limited thereto. Reference may be made to the material of the adhesive AD1 for the material of the adhesive AD6, which will not be repeated here.

The optical element 112 is disposed above the light source element 111. In some embodiments, along the first direction D1 or the second direction D2, the width of the optical element 112 may be greater than the width of the light source element 111. In some embodiments, the groove G1 and the groove G2 are not connected to each other. In some embodiments, the back frame 12 may further include a platform portion P2 for supporting the optical element 112. In some embodiments, the platform portion P2, for example, surrounds the groove G2 and protrudes relative to the groove G2, so that the optical element 112 disposed on the platform portion P2 may maintain an appropriate distance from the light source element 111, which contributes to heat dissipation of the light source element 111 or reducing heat deformation of the optical element 112. In other embodiments, the optical element 112 and the light source element 111 may also selectively be partially in contact with each other. In some embodiments, the optical element 112 may be fixed onto the platform portion P2 through an adhesive AD7, but not limited thereto. Reference may be made to the material of the adhesive AD1 for the material of the adhesive AD7, which will not be repeated here. The adhesive AD7 may be, for example, ring-shaped or divided into multiple sub-portions.

The optical element 112 may include a light guide plate, other light guide elements, or other suitable optical sheets, but not limited thereto. Although FIG. 1B shows that the light source element 111 is disposed below the optical element 112, that is, the architecture of the direct-type backlight module is adopted, in other embodiments not shown, the light source element 111 may be disposed next to a side surface of the optical element 112, that is, the architecture of the side-type backlight module may be adopted.

The optical element 113 is disposed on the optical element 112. In some embodiments, although not shown, the optical element 113 may be fixed onto the optical element 112 through a light transmitting adhesive. In addition, the optical element 113 may include a diffusion sheet to improve light uniformity, but not limited thereto. The optical element 113 may be replaced by other suitable functional sheets according to requirements.

In some embodiments, the optical element 114 is disposed on the optical element 113. In some embodiments, although not shown, the optical element 114 may be fixed onto the optical element 113 through a light transmitting adhesive. The optical element 114 may include a prism sheet, such as a brightness enhancement film, but not limited thereto.

The optical element 110 is disposed on the optical element 114. In some embodiments, although not shown, the optical element 110 may be fixed onto the optical element 114 through a light transmitting adhesive. The optical element 110 is, for example, a dual brightness enhancement film (DBEF) or other suitable functional sheets, but not limited thereto.

In some embodiments, the optical element 110 of the second display 11 and the viewing angle control element 100 of the first display 10 are, for example, roughly coplanar. For example, in the third direction D3, a distance DT2 between the optical element 110 and the protection substrate 13 may be roughly equal to a distance DT1 between the viewing angle control element 100 and the protection substrate 13, but not limited thereto. In addition, the protection substrate 13 includes a viewing surface 13S (that is, a surface away from the back frame 12), a virtual plane SS is roughly parallel to the viewing surface 13S of the protection substrate 13, and the virtual plane SS passes through the viewing angle control element 100 and the optical element 110. In other embodiments, although not shown, the optical element 110 may be omitted, so that there is air at a position where the second display 11 is flush with the viewing angle control element 100. In some embodiments, in the third direction D3, a distance (not labeled) between the optical element 110 and the second panel 115 may be roughly equal to a distance (not labeled) between the viewing angle control element 100 and the first panel 15. In some embodiments, in the third direction D3, the thickness (not labeled) of the optical element 110 and the thickness (not labeled) of the viewing angle control element 100 may be the same or different.

In some embodiments, the second panel 115 and the touch element 116 are sequentially disposed above the optical element 110. In some embodiments, the touch element 116 may be fixed onto a surface of the protection substrate 13 facing the optical element 110 through a light transmitting adhesive AD8, and the second panel 115 may be fixed onto a surface of the touch element 116 facing the optical element 110 through a light transmitting adhesive AD9, but not limited thereto. Reference may be made to the description of the light transmitting adhesive AD3 or the light transmitting adhesive AD4 for the materials of the light transmitting adhesive AD8 and the light transmitting adhesive AD9, but not limited thereto. In other words, the touch element 116 may be disposed between the protection substrate 13 and the second panel 115, the touch element 116 and the protection substrate 13 are fixed through the light transmitting adhesive AD8, and the touch element 116 and the second panel 115 are fixed through the light transmitting adhesive AD9. In some embodiments, the touch element 116 and/or the second panel 115 are, for example, not in contact with the back frame 12, that is, in the first direction D1 or the second direction D2, the touch element 116 and/or the second panel 115 are, for example, spaced from the back frame 12 by a distance (greater than 0), but not limited thereto. In other embodiments (not shown), the touch element 116 and/or the second panel 115 are, for example, partially in contact with the back frame 12, but not limited thereto. In addition, the second panel 115 is, for example, not in contact with the optical element 110, that is, in the third direction D3, there is a distance between the second panel 115 and the optical element 110 to reduce scratching between the second panel 115 and the optical element 110 caused by pressing, thereby improving the display effect. Reference may be made to the description of the touch element 106 for the touch element 116. Reference may be made to the description of the first panel 105 for the second panel 115. The second panel 115 may have an active area R21 and a non-active area R22 adjacent to the active area R21. The active area R21 may be configured to display images (or for other functional applications, such as touch or detection), and the non-active area R22 may be configured to provide peripheral circuits (not shown). In some embodiments, as shown in FIG. 1A, the non-active area R22 may be adjacent to at least one side of the active area R21, and the non-active area R22 may, for example, surround the active area R21, but not limited thereto. In FIG. 1A, in order to clearly illustrate the relative configuration relationship between the optical element 110 and the back frame 12, the edge of the second panel 115 is shown by a thin solid line, and a boundary BR2 between the active area R21 and the non-active area R22 is shown by a thin dotted line.

Although not shown, the optical element 110, the optical element 112, the optical element 113, and the optical element 114 may also include at least one alignment structure, and the back frame 12 may include at least one positioning structure (for example, the positioning structure PS2 as shown in FIG. 1) for fixing with the at least one alignment structure to facilitate assembly. Reference may be made to the above for details.

FIG. 1C is a brightness-viewing angle curve diagram of a first display and a second display in FIG. 1A. In FIG. 1C, a curve C1 is a brightness-viewing angle curve of the first display 10, and a curve C2 is a brightness-viewing angle curve of the second display 11. The vertical axis L % of FIG. 1C is the normalized brightness percentage. As can be seen from FIG. 1C, the first display 10 and the second display 11 may, for example, have the maximum brightness percentage when viewed normal (that is, θ=0° or |θ| is between ±10°), but not limited thereto. The above brightness-viewing angle curve diagrams (the curve C1 and the curve C2) may be measured, for example, through an angle analyzer (for example, model DMS-803, but not limited thereto), an imaging spectrocolorimeter (for example, a Conometer) or other machines with similar functions. For example, the curve C1 and the curve C2 respectively roughly correspond to optical graphs (for example, Cono graphs) measured at the centers of the first display 10 and the second display 11, and are obtained by normalizing the optical graphs. The above brightness-viewing angle curve diagrams (the curve C1 and the curve C2) are, for example, results measured when the first display 10 and the second display 11 are driven to the highest brightness or grayscale.

In addition, please refer to FIG. 1B and FIG. 1C at the same time. Brightness at θ=0° may refer to brightness measured along the third direction D3, |θ| may represent the angle of an included angle between the direction of measurement and the third direction D3, and the greater |θ| is, the more parallel the viewing angle is to a plane (a plane formed by the first direction D1 and the second direction D2). As shown in FIG. 1B, brightness measured at θ=−X° and θ=X° may be exemplified as brightness respectively measured at viewing angles at opposite sides.

Through the design of the first display 10 including the viewing angle control element 100 of the disclosure, the electronic device 1 may provide a multi-screen display with different viewing angle ranges, that is, the viewing angle ranges of the first display 10 and the second display 11 are different. As shown in FIG. 1C, the viewing angle ranges of the first display 10 and the second display 11 being different means that a brightness percentage difference between the respective brightness-viewing angle curve diagrams of the first display 10 and the second display 11 at a viewing angle θ of 30 degrees (that is, θ=±30°) is greater than or equal to 5%. It can be found from FIG. 1C that at the viewing angle θ of 30 degrees (that is, θ=±30°), the brightness percentage difference between the curve C1 and the curve C2 is greater than or equal to 5%. For example, when θ=30°, the brightness percentage difference between the curve C1 and the curve C2 is about 20%, and when θ=−30°, the brightness percentage difference between the curve C1 and the curve C2 is about 30%, but not limited thereto. In some embodiments, the brightness percentage difference between the respective brightness-viewing angle curve diagrams of the first display 10 and the second display 11 at the viewing angle θ of 30 degrees (that is, θ=±30°) is greater than or equal to 5% and less than or equal to 60%, but not limited thereto. In some embodiments, the brightness percentage difference between the respective brightness-viewing angle curve diagrams of the first display 10 and the second display 11 at the viewing angle θ of 30 degrees (that is, θ=±30°) is greater than or equal to 5% and less than or equal to 55%, but not limited thereto. In some embodiments, the brightness percentage difference between the respective brightness-viewing angle curve diagrams of the first display 10 and the second display 11 at the viewing angle θ of 30 degrees (that is, θ=±30°) is greater than or equal to 5% and less than or equal to 50%, but not limited thereto. Through the design of the brightness percentage difference between the brightness-viewing angle curve diagrams at the viewing angle θ of 30 degrees (that is, θ=±30°), the viewing angle ranges of the first display 10 and the second display 11 may be different. FIG. 1C is only an example, and the brightness percentage difference between the curve C1 and the curve C2 may be adjusted according to requirements, that is, L % corresponding to the curve C1 and the curve C2 at θ=±30° is not limited to as shown in FIG. 1C. In addition, the configuration of the viewing angle control element 100 may enable the viewing angle range of the first display 10 to be different from (for example, less than) the viewing angle range of the second display 11. For example, it can be found from FIG. 1C that when L % is 50%, the viewing angle range (for example, +25° to −25°) of the curve C2 is greater than the viewing angle range (for example, +23° to −18°) of the curve C1, but not limited thereto. The difference between the viewing angle ranges of the curve C1 and the curve C2 in FIG. 1C when L % is 50% is only an example and may be adjusted according to requirements. It should be noted that FIG. 1C is only an example, and the relationship between L % and the viewing angles of the curve C1 and the curve C2 may be adjusted according to requirements.

In some embodiments, the first display 10 is, for example, a display corresponding to a front passenger of a vehicle-mounted device, and the second display 11 is, for example, a display corresponding to a driver of the vehicle-mounted device. The viewing angle range of the first display 10 in the first direction D1 may be reduced through the viewing angle control element 100, so as to reduce the interference of an image of the first display 10 on the driver, but not limited thereto. In addition, the interference of the image of the first display 10 reflected onto the windshield on the driver may also be reduced through the viewing angle control element 100. With such design, the driving environment (light brightness) is not limited. The first display 10 may be a high contrast direct-type backlight display, but not limited thereto. In other embodiments, the first display 10 and the second display 11 may also be applied to devices other than the vehicle-mounted device.

Parameters of the viewing angle control element may be adjusted to accommodate diverse designs of any mechanism structure in the transportation device. For example, the design parameters of the viewing angle control element may be adjusted in response to different configuration positions of a display, different sizes or shapes of a configuration region of the display, etc. In addition, since the viewing angle control element is very thin, the electronic device can implement thinner, special-shaped, and/or curved designs.

Please refer to FIG. 2A and FIG. 2B. The main difference between an electronic device 1A and the electronic device 1 of FIG. 1A and FIG. 1B is that the optical element 110 in the second display 11 is replaced with a viewing angle control element 110A, and the viewing angle control element 100 and the viewing angle control element 110A limit viewing angles in different directions. For example, the viewing angle control element 100 limits the viewing angle range of the first display 10 in the first direction D1, and the viewing angle control element 110A limits the viewing angle range of the second display 11 in the second direction D2. For example, the light shielding structures 1000B (may refer to FIG. 5A or FIG. 5B) in the viewing angle control element 100 may be sequentially arranged along the first direction D1 to limit the viewing angle range of the first display 10 in the first direction D1, and the light shielding structures 1000B (may refer to FIG. 5A or FIG. 5B) in the viewing angle control element 110A may be sequentially arranged along the second direction D2 to limit the viewing angle range of the second display 11 in the second direction D2, but not limited thereto. In other embodiments, the viewing angle control element 100 and the viewing angle control element 110A may limit the viewing angles in the same direction (for example, the first direction D1, the second direction D2, or other directions) to different degrees, so that the viewing angle ranges of the first display 10 and the second display 11 are different. In other embodiments, although not shown, the first display 10 and the second display 11 may adopt the architecture of the side-type backlight module. In some embodiments, the design parameters or the arrangement of the light shielding structures 1000B of the viewing angle control element 100 and the viewing angle control element 110A may be different. In some embodiments, the viewing angle control element 110A may also include a first surface (not labeled) adjacent to the protection substrate 13 and a second surface (not labeled) opposite to the first surface (not labeled). In other words, the viewing angle control element 100A includes the first surface (not labeled) adjacent to the viewing side VS of the electronic device and the second surface (not labeled) opposite to the first surface (not labeled). The haze of the first surface (not labeled) may be greater than the haze of the second surface (not labeled). In some embodiments, the haze of the first surface (not labeled) may be less than or equal to 80%, and the haze of the second surface (not labeled) may be greater than 0 and less than or equal to 10%.

Please refer to FIG. 3A and FIG. 3B. The main difference between an electronic device 1B and the electronic device 1 of FIG. 1A and FIG. 1B is that the first display 10 and the second display 11 share the light source element 111, the optical element 112, the optical element 113, the optical element 114, and/or the optical element 110. Multiple grooves (including the groove G1 and the groove G2) of the back frame 12 in FIG. 1B are, for example, integrated into a single groove G, multiple platform portions (including the platform portion P1 and the platform portion P2) of the back frame 12 in FIG. 1B are integrated into a single platform portion P, and the platform portion P, for example, surrounds the groove G. The light source element 111 is, for example, located in the groove G and fixed onto the back frame 12 through the adhesive AD6, and the light source element 111 overlaps with the first panel 105 and the second panel 115 in the third direction D3. The optical element 112 is fixed onto a part of the platform portion P through the adhesive AD7, and the optical element 112 overlaps with the first panel 105 and the second panel 115. The adhesive AD7 is, for example, a patterned adhesive, and the adhesive AD7 is disposed on the platform portion P. In some embodiments, along the first direction D1 or the second direction D2, the width of the optical element 112 may be greater than the width of the light source element 111. The optical element 113 is selectively fixed onto the optical element 112 through a light transmitting adhesive AD10, and in the third direction D3, the optical element 113 overlaps with the first panel 105 and the second panel 115. The optical element 114 is selectively fixed onto the optical element 113 through a light transmitting adhesive AD11, and in the third direction D3, the optical element 114 overlaps with the first panel 105 and the second panel 115. The optical element 110 is selectively fixed onto the optical element 114 through a light transmitting adhesive AD12, and in the third direction D3, the optical element 110 overlaps with the first panel 105 and the second panel 115. The viewing angle control element 100B is selectively fixed onto the optical element 110 through a light transmitting adhesive AD13. The viewing angle control element 100B may selectively not include the reflective polarizer 1003 and the light transmitting adhesive 1004 of FIG. 5A or FIG. 5B, but not limited thereto. The light transmitting adhesive AD10, the light transmitting adhesive AD11, the light transmitting adhesive AD12, and/or the light transmitting adhesive AD13 may include transparent organic or inorganic adhesives, such as optical clear adhesives or optical clear resins, but not limited thereto. In some embodiments, in the third direction D3, the light source element 111, the optical element 112, the optical element 113, the optical element 114, and/or the optical element 110 may overlap at a gap GS between the first panel 105 and the second panel 115.

In other embodiments, although not shown, the first display 10 and the second display 11 may adopt the architecture of the side-type backlight module. In other embodiments, although not shown, the second display 11 may further include another viewing angle control element (for example, the viewing angle control element 110A shown in FIG. 2B). In the embodiment of FIG. 3A and FIG. 3B, the light source element 111 may be selectively driven in different areas to provide light to the optical element or the panel (for example, the first panel 105 or the second panel 115) above in different areas.

Please refer to FIG. 4A and FIG. 4B. The main difference between an electronic device 1C and the electronic device 1B of FIG. 3A and FIG. 3B is that the light transmitting adhesive AD10, the light transmitting adhesive AD11, the light transmitting adhesive AD12, and/or the light transmitting adhesive AD13 are replaced by a patterned adhesive RT, the patterned adhesive RT is, for example, disposed on the viewing angle control element 100B and/or the optical element 110, and the viewing angle control element 100B, the optical element 110, the optical element 114, the optical element 113, and/or the optical element 112 are fixed onto the back frame 12 through the patterned adhesive RT. In some embodiments, the viewing angle control element 100B, the optical element 110, the optical element 114, the optical element 113, and/or the optical element 112 are confined on the platform portion P of the back frame 12 through the patterned adhesive RT. In some embodiments, the patterned adhesive RT includes, for example, a single-sided adhesive, such as a single-sided tape, but not limited thereto. In some embodiments, in the top view direction (for example, the third direction D3), the patterned adhesive RT may have a ring shape. The ring shape may, for example, roughly correspond to the appearance of the back frame 12. In some embodiments (not shown), the patterned adhesive RT may, for example, include multiple sub-portions segmented from each other. In some embodiments, the patterned adhesive RT may extend, for example, to between the adhesive AD5 and the back frame 12 along an inner wall surface 12-1 of the back frame 12, but not limited thereto. In some embodiments, the patterned adhesive RT may be, for example, partially in contact with the inner wall surface 12-1 and/or a top surface 12-2 of the back frame 12, but not limited thereto. The adhesive AD5 is, for example, disposed on the top surface 12-2 of the back frame 12, and the back frame 12 and the protection substrate 13 are fixed to each other through the adhesive AD5, but not limited thereto. In some embodiments, the patterned adhesive RT includes a transparent adhesive, a non-transparent adhesive, or a combination thereof. In some embodiments, the patterned adhesive RT may be, for example, in contact with a part of the viewing angle control element 100B and the optical element 110, and the patterned adhesive RT may be, for example, in contact with a side surface and an upper surface (the surface near the first panel 105) of the part of the viewing angle control element 100B. In some embodiments, in the top view direction (the third direction D3), the patterned adhesive RT may, for example, selectively not overlap with the active area R11 of the first panel 105 and the active area R21 of the second panel 115.

In some embodiments, the appearance of the electronic device may be circular, triangular, other polygonal shapes, or irregular shapes according to actual requirements. Correspondingly, elements (for example, a panel, a viewing angle control element, an optical element, a light source element, and/or a back frame, etc.) in the electronic device also have corresponding appearances. Taking the circular electronic device as an example, as shown in FIG. 6A and FIG. 6B, a viewing angle control element LCF may be, for example, cropped from a rectangle into an appearance close to a circle. The cropped viewing angle control element LCF may include an alignment structure, such as an alignment structure LCFa and/or at least one alignment structure LCFb. Next, the cropped viewing angle control element LCF, a first panel DP1, and a back frame BP may be sequentially assembled together to form an electronic device 1D. The first panel DP1 may include a self-luminous display panel or a non-self-luminous display panel, and the first panel DP1 may include the active area R11 and the non-active area R12. Reference may be made to the above for the detailed content of the active area R11 and the non-active area R12, which will not be repeated here. The viewing angle control element LCF includes at least one alignment structure (for example, the alignment structure LCFa and the alignment structure LCFb). In the top view direction (for example, the third direction D3) of the electronic device, at least one alignment structure (for example, the alignment structure LCFa and the alignment structure LCFb) overlaps with the non-active area R12. The back frame BP may be configured to carry the first panel DP1 and the viewing angle control element LCF, and the back frame BP includes at least one alignment structure (for example, an alignment structure BPa and an alignment structure BPb) for fixing with the at least one positioning structure (for example, the positioning structure LCFa and the positioning structure LCFb). An A element overlapping with a B element mentioned above means that in the top view direction (the third direction D3) of the electronic device, the A element and the B element at least partially overlap.

The viewing angle control element LCF may include a first portion PP1 overlapping with the active area R11 and a second portion PP2 overlapping with the non-active area R12 in the top view direction (the third direction D3) of the electronic device, and the second portion PP2 includes the alignment structure LCFa and/or the alignment structure LCFb.

In some embodiments, the at least one alignment structure may be a recessed portion, a protruding portion, or a through hole of the viewing angle control element LCF. As shown in FIG. 6B, the alignment structure LCFa is, for example, the protruding portion of the second portion PP2 of the viewing angle control element LCF, the alignment structure LCFb is, for example, the through hole of the second portion PP2 of the viewing angle control element LCF, the positioning structure BPa has, for example, a recessed portion roughly complementary to the shape of the alignment structure LCFa, and the positioning structure BPb has, for example, a column that may pass through the through hole (the alignment structure LCFb) of the viewing angle control element LCF, but not limited thereto. The shape of the top view profile of the through hole may not be limited. For example, the shape of the top view profile of the through hole may be circular, elliptical, rectangular, or other shapes. As shown in FIG. 6B, the alignment structure LCFb with a different shape is exemplified and may be configured to distinguish the front and back sides of the viewing angle control element LCF and/or the direction of a light shielding portion.

In some embodiments, the viewing angle control element LCF may adopt the architecture shown in FIG. 5A or FIG. 5B or the above shape variation, and the reflective polarizer 1003 and/or the light transmitting adhesive 1004 may be optionally omitted, but not limited thereto. Reference may be made to the description of FIG. 5A or FIG. 5B for the detailed content of the viewing angle control element LCF, which will not be repeated here.

In some embodiments, as shown in FIG. 6B, the second portion PP2 of the viewing angle control element LCF may include an alignment pattern LCFc. The alignment pattern LCFc is, for example, formed through screen printing, yellow photolithography, or other suitable processes. The material of the alignment pattern LCFc may include metal, ink, a photoresist material, other suitable materials, or a combination thereof. In addition, an alignment pattern DP1a corresponding to the alignment pattern LCFc may also be formed on the non-active area R12 of the first panel DP1 through screen printing or yellow photolithography. Thus, the viewing angle control element LCF and the first panel DP1 may be aligned through the alignment pattern LCFc and the alignment pattern DP1a. The alignment pattern LCFc and the alignment pattern DP1a are, for example, aligned through manual alignment or photosensitive element alignment. In some embodiments, although not shown, the viewing angle control element LCF may be selectively fixed with an adjacent element or film layer through an adhesive (for example, a single-sided adhesive or a double-sided adhesive).

In some embodiments, as shown in FIG. 7A, in addition to the viewing angle control element LCF, the first panel DP1, and the back frame BP, an electronic device 1E may further include a touch element TS and/or a protection substrate CV. Reference may be made to the above description for the detailed content of the touch element TS and the protection substrate CV, which will not be repeated here. In FIG. 7A, the first panel DP1, for example, includes a self-luminous display panel, and the first panel DP1, the viewing angle control element LCF, the touch element TS, and the protection substrate CV are, for example, sequentially disposed on the back frame BP, but not limited thereto. In the embodiment, the light source element or at least some optical elements may be omitted. In other embodiments, although not shown, the viewing angle control element LCF may be disposed between the touch element TS and the protection substrate CV.

In some embodiments, as shown in FIG. 7B, in addition to the viewing angle control element LCF, the first panel DP1, the back frame BP, the touch element TS, and the protection substrate CV, the electronic device 1E may further include a backlight module BL. The backlight module BL may include the light source element 111, and the backlight module BL may be the direct-type backlight module or the side-type backlight module. In FIG. 7B, the first panel DP1 includes, for example, a non-self-luminous display panel, and the backlight module BL, the first panel DP1, the viewing angle control element LCF, the touch element TS, and the protection substrate CV are, for example, sequentially disposed on the back frame BP, but not limited thereto. In other embodiments, although not shown, the viewing angle control element LCF may be disposed between the touch element TS and the protection substrate CV or between the backlight module BL and the first panel DP1.

In summary, in the embodiments of the disclosure, through the design of the first display including the viewing angle control element, the electronic device may provide the multi-screen display with different viewing angle ranges. In some embodiments, the alignment of the viewing angle control element and the back frame is facilitated and the axial direction or the front and back sides of the viewing angle control element are identified through the alignment structure of the viewing angle control element, thereby contributing to the application of the viewing angle control element in the alignment of free shape electronic devices, so as to effectively improve viewing angle control.

The above embodiments are only used to illustrate, but not to limit, the technical solutions of the disclosure. Although the disclosure has been described in detail with reference to the above embodiments, persons skilled in the art should understand that the technical solutions described in the above embodiments may still be modified or some or all of the technical features thereof may be equivalently replaced. However, the modifications or the replacements do not cause the essence of the corresponding technical solutions to depart from the scope of the technical solutions of the embodiments of the disclosure.

Although the embodiments and the advantages of the disclosure have been disclosed above, it should be understood that any person skilled in the art may make changes, substitutions, and modifications without departing from the spirit and the scope of the disclosure, and the features of the embodiments may be arbitrarily mixed and replaced to form other new embodiments. In addition, the protection scope of the disclosure is not limited to processes, machines, manufactures, material compositions, devices, methods, and steps in the specific embodiments described in the specification. Any person skilled in the art may understand conventional or future-developed processes, machines, manufactures, material compositions, devices, methods, and steps from the content of the disclosure as long as the same may implement substantially the same functions or obtain substantially the same results as the embodiments described herein when used according to the disclosure. Therefore, the protection scope of the disclosure includes the above processes, machines, manufactures, material compositions, devices, methods, and steps. In addition, each claim constitutes a separate embodiment, and the protection scope of the disclosure further includes combinations of the claims and the embodiments. The protection scope of the disclosure should be defined by the appended claims.

What is claimed is:

1. An electronic device, comprising:
a first display;
a second display, adjacent to the first display;
a back frame, configured to carry the first display and the second display; and
a protection substrate, disposed on the first display and the second display,
wherein viewing angle ranges of the first display and the second display are different, and the first display comprises a viewing angle control element.

2. The electronic device according to claim 1, wherein the viewing angle ranges being different is defined as a brightness percentage difference between respective brightness-viewing angle curve diagrams of the first display and the second display at a viewing angle of 30 degrees being greater than or equal to 5%.

3. The electronic device according to claim 1, wherein the second display comprises an optical element, and a virtual plane is parallel to a viewing surface of the protection substrate, and the virtual plane passes through the viewing angle control element and the optical element.

4. The electronic device according to claim 1, wherein the first display further comprises a first panel, and the first panel has a non-active area, wherein the viewing angle control element comprises at least one alignment structure, and in a top view direction of the electronic device, the at least one alignment structure overlaps with the non-active area.

5. The electronic device according to claim 4, wherein the at least one alignment structure is a recessed portion, a protruding portion, or a through hole of the viewing angle control element, and the back frame comprises at least one positioning structure for fixing with the at least one alignment structure.

6. The electronic device according to claim 4, wherein the first display further comprises a light transmitting adhesive, and the first panel is fixed onto the protection substrate through the light transmitting adhesive.

7. The electronic device according to claim 6, wherein the first panel and the viewing angle control element are separated from each other.

8. The electronic device according to claim 1, wherein the viewing angle control element comprises a first surface adjacent to the protection substrate and a second surface opposite to the first surface, and a haze of the first surface is greater than a haze of the second surface.

9. The electronic device according to claim 8, wherein the haze of the first surface is less than or equal to 80%, and the haze of the second surface is greater than 0 and less than or equal to 10%.

10. The electronic device according to claim 1, wherein the second display comprises another viewing angle control element, and the another viewing angle control element of the second display and the viewing angle control element of the first display limit viewing angles in different directions.

11. The electronic device according to claim 1, wherein the second display comprises another viewing angle control element, and the another viewing angle control element of the second display and the viewing angle control element of the first display limit viewing angles in a same direction to different degrees.

12. The electronic device according to claim 1, wherein the viewing angle control element of the first display is a non-electrically controlled viewing angle control element.

13. The electronic device according to claim 12, wherein the viewing angle control element of the first display comprises a plurality of light shielding structures, and a ratio of a thickness to a pitch of the light shielding structures is greater than 1 and less than or equal to 10.

14. The electronic device according to claim 12, wherein the viewing angle control element of the first display comprises a plurality of light shielding structures, and a ratio of a distance to a width of the light shielding structures at a surface adjacent to the back frame is greater than or equal to 0.5 and less than or equal to 2.

15. An electronic device, comprising:
a first panel, comprising a non-active area;
a viewing angle control element, comprising at least one alignment structure; and
a back frame, configured to carry the first panel and the viewing angle control element,
wherein in a top view direction of the electronic device, the at least one alignment structure overlaps with the non-active area, and the back frame comprises at least one positioning structure for fixing with the at least one alignment structure.

16. The electronic device according to claim 15, wherein the at least one alignment structure is a recessed portion, a protruding portion, or a through hole of the viewing angle control element.

17. The electronic device according to claim 15, wherein the viewing angle control element comprises a first surface adjacent to a viewing side of the electronic device and a second surface opposite to the first surface, and a haze of the first surface is greater than a haze of the second surface.

18. The electronic device according to claim 17, wherein the haze of the first surface is less than or equal to 80%, and the haze of the second surface is greater than 0 and less than or equal to 10%.

19. The electronic device according to claim 15, further comprising:
a protection substrate, disposed on the first panel;
an adhesive, wherein the protection substrate is fixed onto the back frame through the adhesive; and
a light transmitting adhesive, wherein the first panel is fixed onto the protection substrate through the light transmitting adhesive.

20. The electronic device according to claim 19, wherein the first panel and the viewing angle control element are separated from each other.
